(19) United States
(12) Patent Application Publication
(10) Pub. No.: US 2024/0300591 A1
(43) Pub. Date: Sep. 12, 2024

(54) TAILGATE ASSEMBLY AND ADD-ON TAILGATE ASSEMBLY

(71) Applicant: SOUCY INTERNATIONAL INC., Drummondville (CA)

(72) Inventors: Gabriel BOISVERT, Beloeil (CA); Mathieu LALANCETTE-JUTRAS, Drummondville (CA); Tommy ROY, Saint-Lucien (CA); Michael CHARRETTE, St-Felix de Kingsey (CA)

(21) Appl. No.: 18/597,773

(22) Filed: Mar. 6, 2024

Related U.S. Application Data
(60) Provisional application No. 63/450,288, filed on Mar. 6, 2023.

(51) Int. Cl. B62D 33/027; B60R 3/02; B60R 7/02

(52) U.S. Cl. CPC B62D 33/0273; B60R 3/02; B60R 7/02

(57) ABSTRACT

A tailgate assembly includes a tailgate body, a tailgate sub-body and a link. The tailgate body is pivotable relative to a vehicle about a first axis between first and second positions, and defines at least one storage area. The tailgate sub-body is connected to the tailgate body, and is moveable relative thereto between third and fourth positions. The link is connected to the tailgate body and the tailgate sub-body, and is moveable between a first link position, in which the tailgate sub-body is in the third position, and a second link position, in which the tailgate sub-body is in the fourth position. With the tailgate body in the first position, and the link in the first link position, the tailgate assembly is in a first configuration. With the tailgate body in the second position, and the link in the second link position, the tailgate assembly is in a second configuration.

### CROSS-REFERENCE TO RELATED APPLICATION

The present application claims priority to U.S. Provisional Patent Application No. 63/450,288, filed Mar. 6, 2023 entitled “Tailgate Assembly for Vehicle”, which is incorporated by reference herein in its entirety.

### TECHNICAL FIELD

The present technology relates to tailgate assemblies and add-on tailgate assemblies.

### BACKGROUND

Users of utility terrain vehicles (UTV), such as pickup trucks, a side-by-side vehicles (SSV) or an all-terrain vehicles (ATV) and the like are continually looking for ways to improve and maximize use of their vehicle.

For instance, UTVs are typically equipped with cargo areas, and may include features to attach, tie-down, hold and/or store various accessories and objects therein. Generally, cargo areas are provided with tailgate assemblies that can open and close for providing and restricting access to the cargo area.

However, even if vehicle manufacturers have recognized the potential of providing tailgate assemblies with additional functions incorporated thereinto for increasing its utility, there are cases where the specific needs of some users are not being met and where additional features would still deemed desirable, which can result in users using conventional tailgate assemblies in ways that may not be safe or practical.

### SUMMARY

It is an object of the present technology to ameliorate at least some of the inconveniences present in the prior art.

According to one aspect of the present technology, there is provided a tailgate assembly for a vehicle. The tailgate assembly includes a tailgate body, a tailgate sub-body and a link. The tailgate body is pivotally connectable to the vehicle about a first axis, and defines, relative to the vehicle, a first tailgate body position and a second tailgate body position. The tailgate body defines at least one storage area configured to receive at least one object. The tailgate sub-body is pivotally connectable to the tailgate body about a second axis and defines, relative to the tailgate body, a first tailgate sub-body position and a second tailgate sub-body position. The link connects the tailgate body to the tailgate sub-body via at least one set of two attachment points. A first set of two attachment points is configured to position the tailgate sub-body in the first tailgate sub-body position, and a second set of two attachment points is configured to position the tailgate sub-body in the second tailgate sub-body position. A plurality of combinations of at least one of the first and second tailgate body positions relative to the vehicle with at least one of the first and second tailgate sub-body positions relative to the tailgate body forms a plurality of different configurations for different usage of the tailgate assembly by a user.

In some embodiments, one of the plurality of different configurations an additional work surface.

In some embodiments, one of the plurality of different configurations forms a step.

In some embodiments, the tailgate body is hollow and configured to provide internal storage.

In some embodiments, the tailgate body is configured to provide provisions for an extension sub-assembly.

In some embodiments, the tailgate sub-body is configured to provide provisions for mounting an accessory.

In some embodiments, the tailgate assembly is configured to replace an existing tailgate assembly on the vehicle.

In some embodiments, the tailgate assembly is configured to be installed onto an existing tailgate assembly on the vehicle.

According to another aspect of the present technology, there is provided a tailgate assembly for a vehicle. The tailgate assembly includes a tailgate body, a tailgate sub-body and a link. The tailgate body is removably connectable to a tailgate of the vehicle, and defines, relative to the vehicle, a first tailgate position and a second tailgate position. The tailgate body defines at least one storage area configured to receive at least one object. The tailgate sub-body is pivotally connectable to the tailgate body about a second axis, and defines, relative to the tailgate body, a first position and a second position. The link connects the tailgate body to the tailgate sub-body via attachment points. A first set of two attachment points is configured to position the tailgate sub-body in the first position, and a second set of two attachment points is configured to position the tailgate sub-body in the second position. A plurality of combinations of at least one of the first and second tailgate positions relative to the vehicle with at least one of the first and second positions of the tailgate sub-body relative to the tailgate body forms a plurality of different configurations for different usage of the tailgate assembly by a user.

In some embodiments, one of the plurality of different configurations an additional work surface.

In some embodiments, one of the plurality of different configurations forms a step.

In some embodiments, the tailgate body is hollow and configured to provide internal storage.

In some embodiments, the tailgate body is configured to provide provisions for an extension sub-assembly.

In some embodiments, the tailgate sub-body is configured to provide provisions for mounting an accessory.

In some embodiments, the tailgate assembly is configured to be installed onto an existing tailgate assembly on the vehicle.

In some embodiments, the tailgate body is a liner covering at least one surface of the tailgate of the vehicle.

According to another aspect of the present technology, there is provided a vehicle comprising a cargo area and the tailgate assembly of claim 1.

According to another aspect of the present technology, there is provided a tailgate assembly for a vehicle. The tailgate assembly includes a tailgate body, a tailgate sub-body and a link. The tailgate body is pivotally connectable to the vehicle. The tailgate body is pivotable relative to the vehicle about a first axis between a first position and a second position, and defines at least one storage area. The tailgate sub-body is connected to the tailgate body, and is moveable relative to the tailgate body between a third position and a fourth position. The link is connected to the tailgate body and the tailgate sub-body. The link is moveable between a first link position, in which the tailgate sub-body is in the third position, and a second link position, in which the tailgate sub-body is in the fourth position. With the tailgate body in the first position, and the link in the first link position, the tailgate assembly is in a first configuration. With the tailgate body in the second position, and the link in the second link position, the tailgate assembly is in a second configuration.

In some embodiments, the link is selectively connected to at least one of the tailgate body and the tailgate sub-body.

In some embodiments, the link is selectively connected to the tailgate body via one of: a first attachment point and a second attachment point.

In some embodiments, the tailgate sub-body is pivotable about a second axis.

In some embodiments, in one of the first and second configurations, the tailgate sub-body provides a work surface.

In some embodiments, in one of the first and second configurations, the tailgate assembly is configured to support a work surface.

In some embodiments, in one of the first and second configurations, the tailgate sub-body provides a stepping surface.

In some embodiments, the tailgate body is at least partially hollow and the storage is an internal storage.

In some embodiments, the tailgate body is configured to receive an extension assembly.

In some embodiments, the tailgate body includes an extension assembly.

In some embodiments, the extension assembly includes telescoping members.

According to another aspect of the present technology, there is provided a vehicle having a cargo area and a tailgate assembly according to the above aspect or according to above aspect and one or more of the above embodiments.

According to another aspect of the present technology, there is provided an add-on tailgate assembly connectable to an existing tailgate. The add-on tailgate assembly includes a tailgate body moveably connectable to the tailgate, the tailgate body being moveable relative to the existing tailgate between a first position and a second position.

Additional and/or alternative features, aspects, and advantages of implementations of the present technology will become apparent from the following description, the accompanying drawings, and the appended claims.

### BRIEF DESCRIPTION OF THE DRAWING

For a better understanding of the present technology, as well as other aspects and further features thereof, reference is made to the following description which is to be used in conjunction with the accompanying drawings, where:

FIG. 1 is a perspective view taken from a top, rear, right side of a vehicle having a tailgate assembly according to one embodiment of the present technology;

FIG. 2 is a perspective view taken from a top, rear, left side of the tailgate assembly of FIG. 1, with the tailgate assembly being in a closed configuration;

FIG. 3 is a perspective view taken from a top, rear, left side of the tailgate assembly of FIG. 1, with the tailgate assembly being in an open configuration;

FIG. 4 is a perspective view taken from a top, rear, left side of the tailgate assembly of FIG. 1, with a tailgate sub-body 104 being moved from a closed position to an open position;

FIG. 5 is a perspective view taken from a top, rear, left side of the tailgate assembly of FIG. 1, with a tailgate sub-body 104 being moved from a closed position to a first open position;

FIG. 6 is a perspective view taken from a top, rear side of the tailgate assembly of the tailgate assembly of FIG. 1, with the tailgate assembly being in the open configuration, and with studs being received in the tailgate assembly;

FIG. 7 is a perspective view taken from a top, rear, left side of the tailgate assembly of FIG. 1, with the tailgate assembly being in a tabling configuration;

FIG. 8 is a perspective view taken from a top, rear, left side of the tailgate assembly of FIG. 1, with the tailgate assembly being in a step configuration;

FIG. 9 depicts partially exploded perspective views of the tailgate assembly of FIG. 1;

FIG. 10 is a perspective view taken from a top, rear, right side of a tailgate assembly according to an alternative embodiment of the present technology;

FIG. 11A depicts a tailgate assembly according to an alternative embodiment of the present technology, with sub-bodies thereof being moved from retracted to extended positions;

FIG. 11B is a perspective view taken from a top, rear, right side of a tailgate assembly according to an alternative embodiment of the present technology;

FIGS. 12 to 16 depict tailgate assemblies according to alternative embodiments of the present technology;

FIG. 17 depicts various movements of components of tailgate assemblies according to some embodiments of the present technology;

FIGS. 18 and 19 depicts a tailgate assembly according to an alternative embodiment of the present technology;

FIG. 20 depicts a tailgate assembly according to an alternative embodiment of the present technology;

FIG. 21 depicts a partially exploded perspective view of an add-on tailgate assembly according to an embodiment of the present technology being connected to an existing tailgate;

FIGS. 22 and 23 depict an add-on tailgate assembly according to an alternative embodiment of the present technology; and

FIG. 24 is a conventional tailgate with accessories being disposed thereon.

### DESCRIPTION OF EMBODIMENTS

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

For purposes of this application, terms related to spatial orientation such as forwardly, rearward, upwardly, downwardly, left, and right, are as they would normally be understood by an operator of the vehicle sitting thereon in a normal riding position. Terms related to spatial orientation when describing or referring to components or sub-assemblies of the vehicle, separately from the vehicle, such as a tailgate assembly for example, should be understood as they would be understood when these components or sub-assemblies are mounted to the vehicle, unless specified otherwise in this application.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

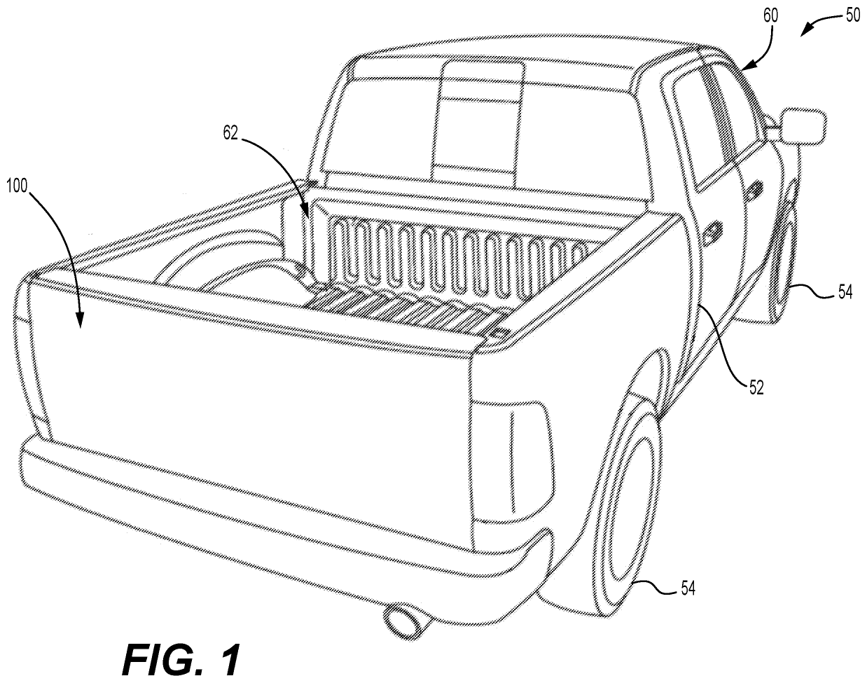

The present technology will be described with reference to a vehicle 50. In the embodiment illustrated in FIG. 1, the vehicle 50 is a pickup truck. However, it is contemplated that the vehicle could be another type of vehicle such as a UTV, a SSV or an ATV.

The vehicle 50 has a frame 52. The frame 52 supports a motor (not shown). It is contemplated that the motor may be an electric motor or an internal combustion engine. The vehicle 52 also has four wheels 54 (only front right wheel and rear right wheel shown in FIG. 1) that are operatively connected to the motor. In other embodiments, only some of the four wheels 54 may be operatively connected to the motor.

The frame 52 has a passenger cabin 60 for, inter alia, receiving passengers therein, and a cargo box 62 disposed rearwardly from the passenger cabin 60.

The vehicle 50 also includes a tailgate assembly 100 according to an embodiment of the present technology. The tailgate assembly 100 connected to the vehicle 50, and is disposed at a rear of the cargo box 62. In the present embodiment, the tailgate assembly 100 has been manufactured with the vehicle 50. In other embodiments, the tailgate assembly 100 may be a replacement tailgate assembly 100 that has replaced an original tailgate assembly. As will be described below, the tailgate assembly 100 is moveable to, inter alia, close the cargo box 62 and to provide access to the cargo box 62.

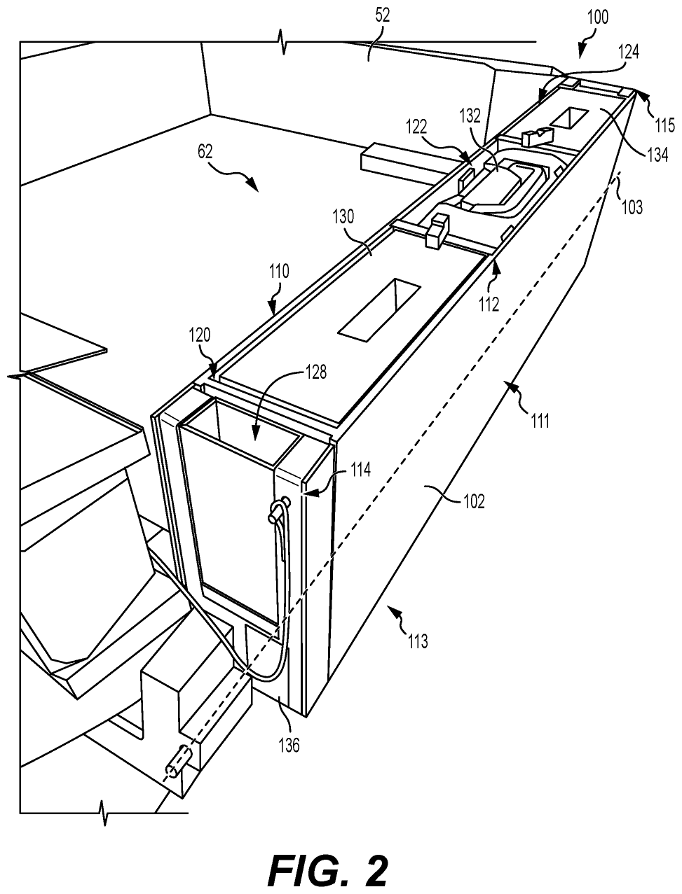

Referring to FIGS. 2 to 8, the tailgate assembly 100 includes a tailgate body 102, a tailgate sub-body 104 and links 106 configured to connect the tailgate sub-body 104 to the tailgate body 102.

The tailgate body 102 is moveably connected to the vehicle 50 such that the tailgate body 102 can be moved between a plurality of positions.

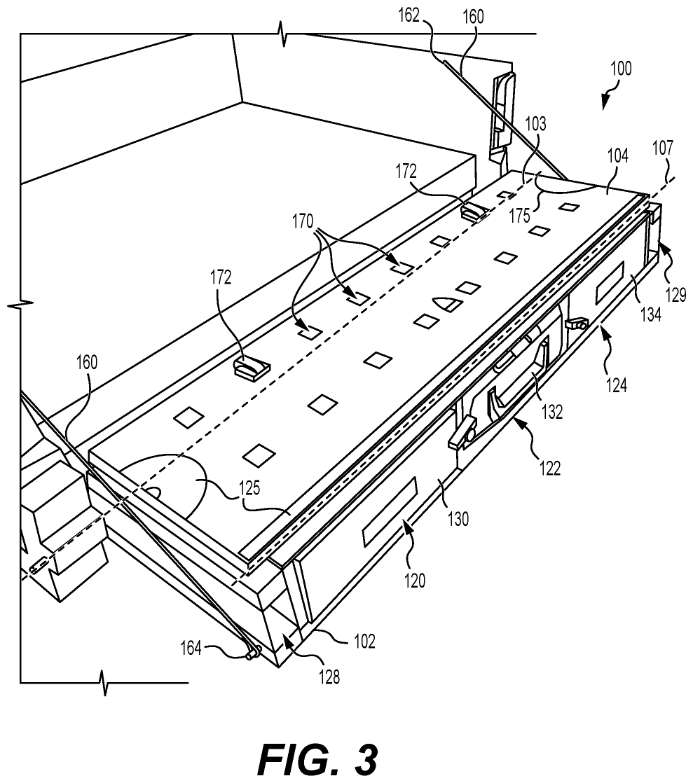

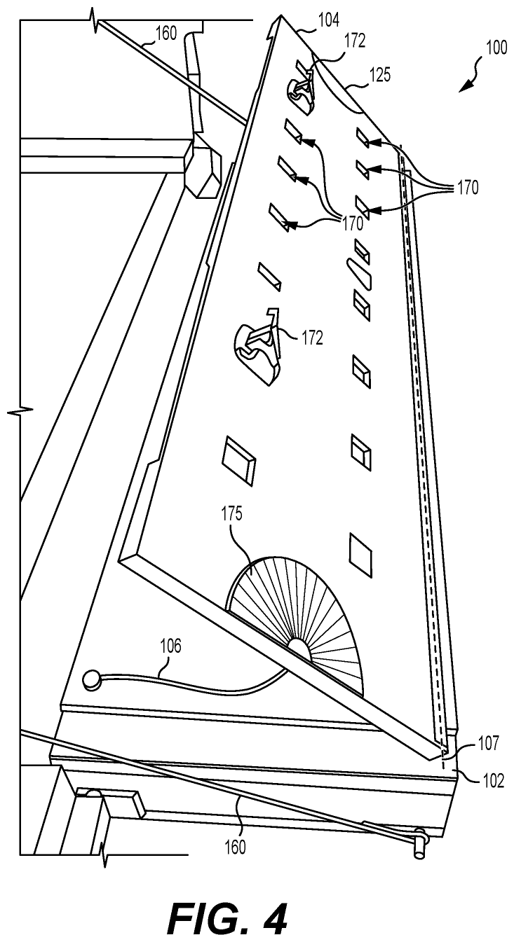

In the embodiment illustrated in FIGS. 2 to 8, the tailgate body 102 is pivotally connected to the frame 52. More specifically, the tailgate body 102 is, with respect to the frame 52, pivotable about an axis 103 between a closed position (FIG. 2), a first open position (FIG. 3), and a second open position (FIG. 4). The axis 103 extends generally horizontally, and is disposed toward a bottom side 113, and a front side 110 of the tailgate body 102. It is contemplated that the tailgate body 102 could be connected to the vehicle 50 differently. For example, in some embodiments, the axis 103 may extend vertically. In yet further embodiments, the tailgate body 102 may be selectively connected to the frame 52, such that when desired and/or required, the tailgate body 102 may be fully disconnected from the vehicle 50.

The tailgate body 102, which has the front side 110, a rear side 111, a top side 112, the bottom side 113 and lateral sides 114, 115, has a generally prismatic shape. The prismatic shape is sized and configured to fit between lateral sides of the cargo box 62. In the illustrated embodiment, there is a single tailgate body 102, but it is contemplated that in other embodiments, there may be two or more separate tailgate bodies.

The tailgate body 102 is configured to provide storage. The storage, also referred to as storage areas, storage chambers and/or storage sections, may be considered to be “static” (e.g., a cavity, a receptacle, a divider, a container, etc.) and/or “dynamic” (e.g., a drawer, a sliding/telescoping portion, a pivoting/openable portion, etc.).

More specifically, the tailgate body 102 defines three recesses 120, 122, 124. The recesses 120, 122, 124 extend from the top side 112 of the tailgate body 102 toward the bottom side 113 thereof. It is contemplated that one or more of the recesses 120, 122, 124 may extend differently.

The recesses 120, 122, 124 are configured to receive, respectively, storage containers 130, 132, 134. The storage containers 130, 134 are integrated drawers 130, 134, whereas the storage container 132 is a removable case 132. The integrated drawers 130, 134 are preferably not removed from their respective recesses 120, 124, though it is contemplated that may be possible. The removable case 132 is configured to be easily removable and insertable from and into the recess 122. It is contemplated that in some embodiments, all three of the storage containers 130, 132, 134 may be integrated drawers or removable cases. Other types of containers are contemplated as well. It is further contemplated that there may be more or less than three recesses 120, 122, 124 and/or three storage containers 130, 132, 134. It is further contemplated that in some instances, the tailgate body 102 may simply have a cover closing a respective one of the recesses (i.e., a recess does not necessarily need a storage container).

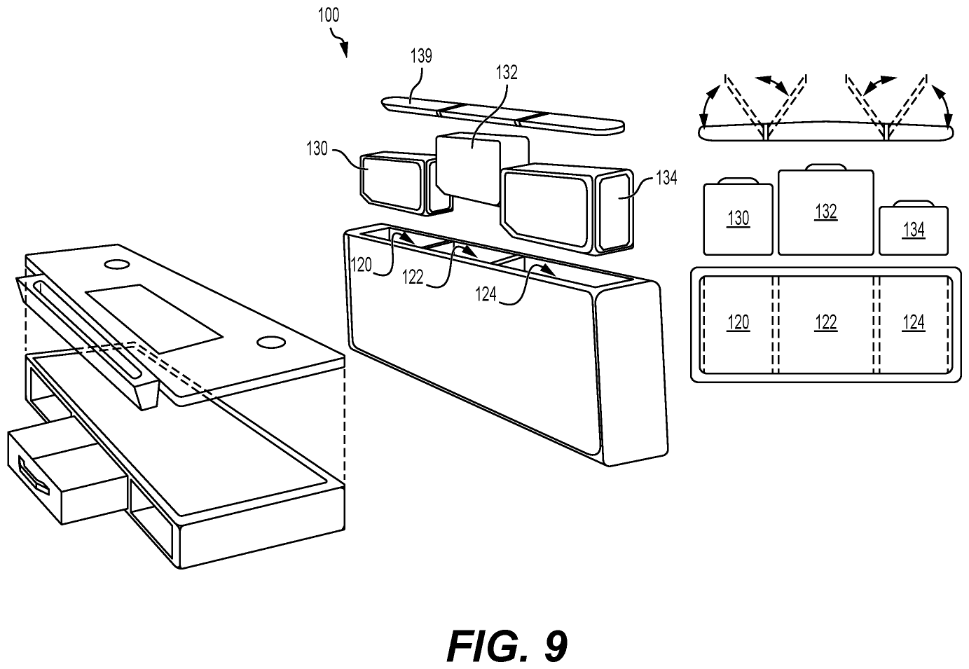

As illustrated in FIG. 9, in some embodiments, the tailgate assembly 100 may further include a seal 139 for sealing the recesses 120, 122, 124 and the storage containers 130, 132, 134. This can assist in, notably, protecting items stored in the recesses 120, 122, 124 and the storage containers 130, 132, 134 from elements such as water, humidity and/or debris.

It will be appreciated that the orientation of the recesses 120, 122, 124 in the present embodiment enable the storage containers 130, 132, 134 to be accessible in more than one position of the tailgate body 102. Thus, the storage containers 130, 132, 134 can be accessed when the tailgate assembly 100 is in a closed configuration (FIG. 2) or when the tailgate assembly 100 is in an open configuration (FIG. 3).

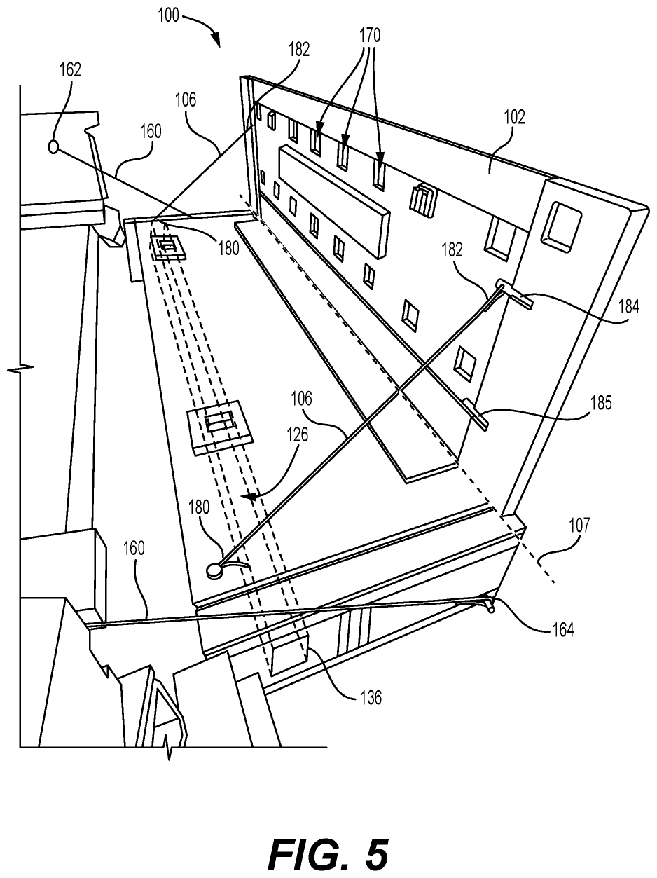

The tailgate body 102 further defines a through storage recess 126 (shown in dotted lines in FIG. 5). The storage recess 126 extends from the lateral side 114 to the lateral side 115. It is contemplated that the storage recess 126 may extend differently (e.g., from the lateral side 114 to about halfway toward the lateral side 115). The storage recess 126 is closed by a panel 136. It is understood that the storage recess 126 may be closed differently, such as, for example by a latch, a net, a door, a flap or a cap. In other embodiments, the storage recess 126 may be “free” in the sense that the storage recess 126 is not closed by any panel (i.e., access to the storage recess 126 is always provided). In the illustrated embodiment, being that the storage recess 126 extends along the longest side of the tailgate body 102, the storage recess 126 can receive longer objects therein, such as fishing rods.

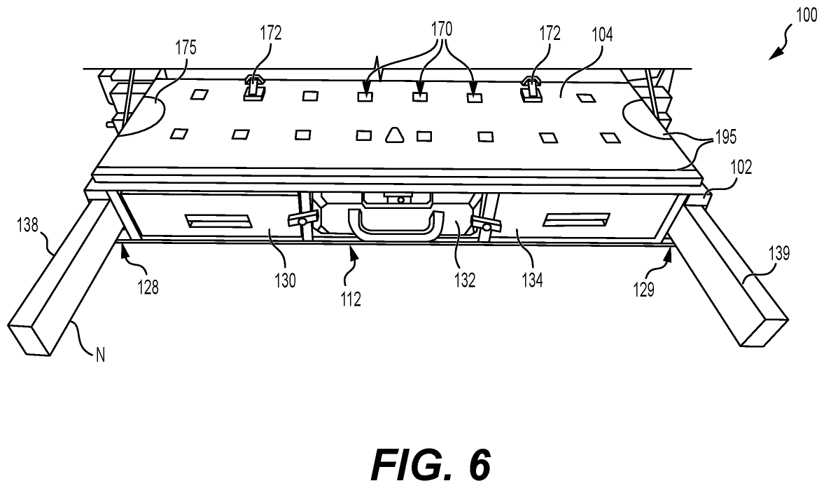

The tailgate body 102 further defines an extension recess 128 on the lateral side 114, to the left of the recess 120, and an extension recess 129 on the lateral side 115, to the right of the recess 124. Similarly to the recesses 120, 122, 124, the extension recesses 128, 129 extend from the top side 112 toward the bottom side 113. The extension recesses 128, 129 are configured to selectively receive extension members 138, 139 (shown in FIG. 6) therein. The extension recesses 128, 129 may be sized and shaped to receive readily available extension members 138, 139. For example, in FIG. 6, the extension members 138, 139 are studs 138, 139, which are 2 inches by 4 inches. It will be appreciated that sometimes, the studs 138, 139 may be placed into the extension recesses 128, 129 so that they are stable, and then they may be cut as desired. The extension recess 128, 129 are configured such that the extension members 138, 139 extend away from the top side 112. It is contemplated that the extension members 138, 139 may extend away from the lateral sides 114, 115.

Other extension members 138, 139 such as custom metallic members are contemplated. It is also contemplated that the extension recesses 128, 129 may be omitted, and the extension members 138, 139 may be integrated into the tailgate body 102. For example, the extension members 138, 139 may be provided as telescopic, slidable, foldable and/or pivotable members, with the extension members 138, 139 being selectively deployable between retracted and contracted positions.

Due to the recesses defined in the tailgate body 102, the tailgate body 102 can be said to be partially hollow. It is contemplated that the number and/or size of the recesses, which may be referred to as storage recesses, storage areas and/or storage sections, may vary from one embodiment to another. Additionally, it is contemplated that one or more of the recesses may be accessible from the front, rear, top, bottom, and lateral sides 110, 111, 112, 113, 114, 115 of the tailgate body 102.

The tailgate body 102 is further provided with a locking assembly that is configured to lock the tailgate body 102 in the closed position. The locking assembly can include various members such as latches, straps, fasteners, and pins-holes connections. In some cases, the locking assembly is the same, or is similar to the locking assembly originally provided by a manufacturer of the vehicle 50 to lock the original tailgate. It is contemplated that the locking assembly may be provided on any of the front, rear, top, bottom, and lateral sides 110, 111, 112, 113, 114, 115 of the tailgate body 102 to lock the tailgate assembly 100 to the vehicle 50.

The tailgate body 102 also includes positioning links 160. In the illustrated embodiment, the positioning links 160 are flexible cables. Other positioning links 160 such as linkage mechanisms are contemplated. Each positioning link 160 has one end 162 that is connected to the frame 52 and an other end 164 that is connected to the tailgate body 102. In some cases, the positioning links 160 may be selectively connected to the frame 52 and/or to the tailgate body 102. That is, the end 162 may be selectively connected to the frame 52 and/or the end 164 may be selectively connected to the tailgate body 102.

The positioning links 160 are configured to position the tailgate body 102 in at least one position other than the closed position relative to frame 52. More specifically, in the present embodiment, the positioning links 160 are configured to secure the tailgate body 102 in the first open position (FIG. 3) and in the second open position (FIG. 4). In some cases, this may be possible by moving a point of connection between the ends 164 and the tailgate body 102 and/or by moving a point of connection point between the ends 162 and the frame 52.

It is contemplated that the tailgate body 102 may include connectors for connecting accessories and/or objects thereto. For example, the connectors, which may be referred to as mounting members, may be configured to mount an accessory such as a vise, a work plate, a magnetic plate, a given tool, a fishing rod or a fishing rod holder, and/or a laptop. The connectors may be disposed on any one of the front, rear, top, bottom, and lateral sides 110, 111, 112, 113, 114, 115. In some instances, the connectors may be apertures configured to receive fasteners therein or rails (e.g., t-slot) for continuous positioning of a fastener (e.g., t-nut) to mount the accessory or to provide a tie-down point along the rails. In some cases, the connectors could be configured to receive specific quick-attach assemblies.

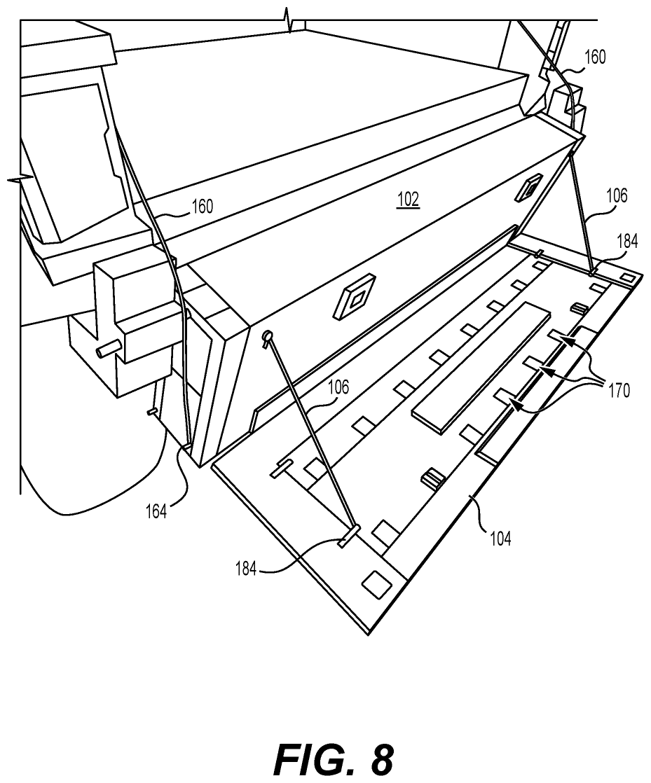

The tailgate body 102 in its different positions will now be described. As mentioned above, the tailgate body 102 is pivotable about the axis 103 between the closed position (FIG. 2), the first open position (FIG. 3) and the second open position (FIG. 8).

In the closed position, the tailgate body 102 is positioned such that the front side 110 is generally vertical and generally perpendicular with a bed of the cargo box 62, and that the top side 112 is the topmost side of the tailgate body 102. In the closed position, the tailgate body 102 closes the cargo box 62.

In the first open position, the tailgate body 102 is positioned such that the front side 110 is generally horizontal and generally parallel with the bed of the cargo box 62, and that the top side 112 is the rearmost side of the tailgate body 102.

In the second open position, the tailgate body 102 is positioned such that the front side 110 is generally vertical, and generally perpendicular with the bed of the cargo box 62, and that the top side 112 is the lowermost side of the tailgate body 102 (i.e., the bottom side 113 is the topmost side of the tailgate body 102).

It is contemplated that the tailgate body 102 may be moveable to other positions, with some positions being disposed intermediate to the closed and the first open positions, and other positions being disposed beyond the closed and/or second open positions. For example, the tailgate body 102 may be pivoted beyond the closed position, such that it is generally disposed within the cargo area. It is thus contemplated that the range of motion of the tailgate body 102 may vary from one embodiment to another. In some embodiments, the tailgate body 102 may only be moveable between the closed position and the first open position.

Still referring to FIGS. 2 to 8, the tailgate sub-body 104 will now be described in greater detail.

The tailgate sub-body 104 is sized and shaped generally similarly to the size and shape of the tailgate body 102. In other embodiments, the tailgate sub-body 104 may be smaller and/or have a different shape from the tailgate body 102.

The tailgate sub-body 104 defines a plurality of apertures 170 configured to receive one or more fasteners. The plurality of apertures 170 enable the mounting of an accessory at multiple discrete positions. It is contemplated that there could be a single aperture 170 for receiving one single fastener. In the illustrated embodiment, the plurality of apertures 170 are sized and shaped to receive specific quick-attach mechanisms 172. In some instances, the tailgate sub-body 104 may, in addition to, or instead of, the plurality of apertures 170, provide one or more rails (e.g., t-slot) for continuous positioning of a fastener (e.g., t-nut) for mounting an accessory or for providing a tie-down point along the one or more rails.

The tailgate sub-body 104 includes a plurality of measuring tools 175. The plurality of measuring tools includes a measuring tape 175, a scale protractor 175 and/or a level indicator 175. The measuring tools 175 are disposed on either side (internal and external sides) of the tailgate sub-body 104. It is contemplated that one or more of the plurality of measuring tools 175 may be disposed on the tailgate body 102. The tailgate sub-body 104 further has an abutting portion 176 which may assist a worker in performing some work (e.g., cutting an object).

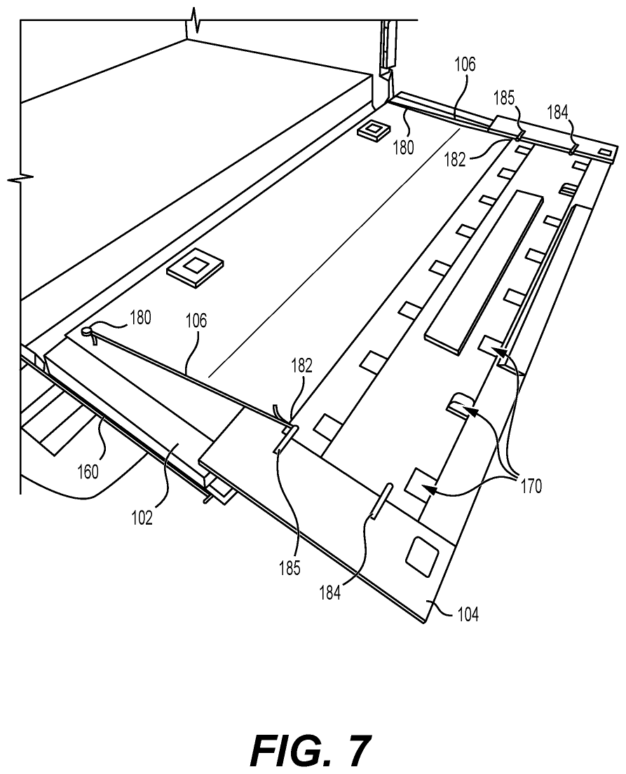

The tailgate sub-body 104 is moveably connected to the tailgate body 102. In the embodiment illustrated in FIGS. 2 to 8, the tailgate sub-body 104 is pivotally connected to the tailgate body 102. More specifically, the tailgate sub-body 104 is connected to the tailgate body 102 by a hinge such that the tailgate sub-body 104 is pivotable, with respect to the tailgate body 102, about an axis 107 between a retracted position (which may be referred to as a closed sub-body position, and shown in FIGS. 2, 3 and 6), a first extended position (which may be referred to as an open sub-body position, and shown in FIG. 5), and a second extended position (which may also be referred to as an open-sub body position, and shown in FIG. 7). The axis 107 extends generally horizontally, and is disposed toward the top side 112, and the front side 110 of the tailgate body 102 such that the tailgate sub-body 104 can pivot outwardly or away from the vehicle 50. Other configurations are contemplated.

It is contemplated that the tailgate body 102 could be connected to the vehicle 50 differently. For example, in some embodiments, the axis 107 may be oriented to extend between the top and bottom sides 112, 113 of the tailgate body 102. In yet further embodiments, the tailgate sub-body 104 may be selectively connected to the tailgate body 102, such that when desired and/or required, the tailgate sub-body 102 may be fully disconnected from the tailgate body 102.

In some cases, the tailgate sub-body 104 may be moveable between open and first and second closed positions linearly with respect to the tailgate body 102 (instead of pivotally). In such cases, the tailgate sub-body 104 may have a telescoping configuration with the tailgate body 102 and/or the tailgate sub-body 104 may be configured to slide on rails of the tailgate body 102. In some cases, the tailgate sub-body 104 may act as a liner covering for one of the sides of the tailgate body 102. In yet other cases, the tailgate sub-body 104 may be moveable in a combination of more than one translational and/or pivotal movements relative to the tailgate body.

The links 106 are connected to the tailgate body 102 and to the tailgate sub-body 104, each one of the links 106 being disposed on either one of the lateral sides 114, 115. In some embodiments, the links 106 may be referred to as connecting links 106. It is contemplated that the position and/or the number of links 106 may vary. Each link 106 has an end 180 connected to the tailgate body 102 and an other end 182 connected to the tailgate sub-body 104. The ends 180, 182 may be removably connected from, respectively, the tailgate body 102 and the tailgate sub-body 104. The links 106 are configured to secure the tailgate sub-body 104 in at least one position other than the closed position relative to the tailgate body 102.

In the present embodiment, the tailgate sub-body 104 has upper connectors 184 and lower connectors 185. The ends 182 of the links 106 may be selectively connected to the upper connectors 184 for securing the tailgate sub-body 104 in the first extended position, or to the lower connectors 185 for securing the tailgate sub-body 104 in the second extended position. It can be said that when the ends 182 are connected to the upper connectors 184, the links 106 are in one position, and when the ends 182 are connected to the upper connectors 185, the links 106 are in another position. Additional connectors are contemplated. It is also contemplated that in some embodiments, the links 106 could have their ends 180, 182 received in rails and/or slots disposed on the tailgate body 102 and/or the tailgate sub-body 104.

When the tailgate sub-body 104 is in the retracted position, the tailgate sub-body 104 may be secured to the tailgate sub-body 104 with a sub-body locking assembly. In one embodiment, the tailgate sub-body 104 may be secured to the tailgate body 102 via a fastener extending through the tailgate sub-body 104 and connecting with the tailgate body 102.

Still referring to FIGS. 2 to 8, the tailgate assembly 100 in different configurations will now be described. It will be appreciated that a plurality of combinations of at least one of the closed position, the first open position, and the second open position of the tailgate body 102 with at least one of the retracted position, first extended position and second extended position of the tailgate sub-body 104 provides a plurality of different configurations, with the tailgate assembly 100 providing a different usage in different configurations.

Referring to FIG. 2, the tailgate assembly 100 is in the closed configuration. In this configuration, the tailgate body 102 is in the closed position, and the tailgate sub-body 104 is in the retracted position. In this configuration, the tailgate assembly 100 is generally configured to close access to the cargo box 62.

Referring to FIG. 3, the tailgate assembly 100 is in the open configuration. In this configuration, the tailgate body 102 is in the first open position, and the tailgate sub-body 104 is in the retracted position. In this configuration, access to the cargo box 62 is provided. It will be appreciated that due to the tailgate sub-body 102 being connected to the front side 110 of the tailgate body 102, the quick attach mechanisms 172 are accessible (i.e., any accessory connected thereto would be easily accessible).

Referring to FIG. 7, the tailgate assembly 100 is in the tabling configuration. In this configuration, the tailgate body 102 is in the first open position. The extension members 138, 139 are received in the extension recesses 128, 129. The ends 182 of the links 106 are connected to the lower connectors 185, such that the tailgate sub-body 104 is in the second extended position, and is in part supported by the extension members 138, 139, such the tailgate body 104 can sustain load thereon. In this configuration, the tailgate body 102 and the tailgate sub-body 104 may form a working surface that is stable and safe, with different provisions to mount work tools thereon.

Referring to FIG. 8, the tailgate assembly 100 is in the stepping configuration. In this configuration, the tailgate body 102 is in the second open position. The ends 182 of the links 106 are connected to the upper connectors 184, such that the tailgate sub-body 104 is in the first extended position. In this configuration, the tailgate body 102 and the tailgate sub-body 104 may form a stepping surface. More specifically, someone may step onto tailgate sub-body 104 to climb onto the cargo box 63.

Other configurations of the tailgate assembly are contemplated.

In some embodiments, the tailgate assembly 100 may only be adjustable to some of the plurality of configurations.

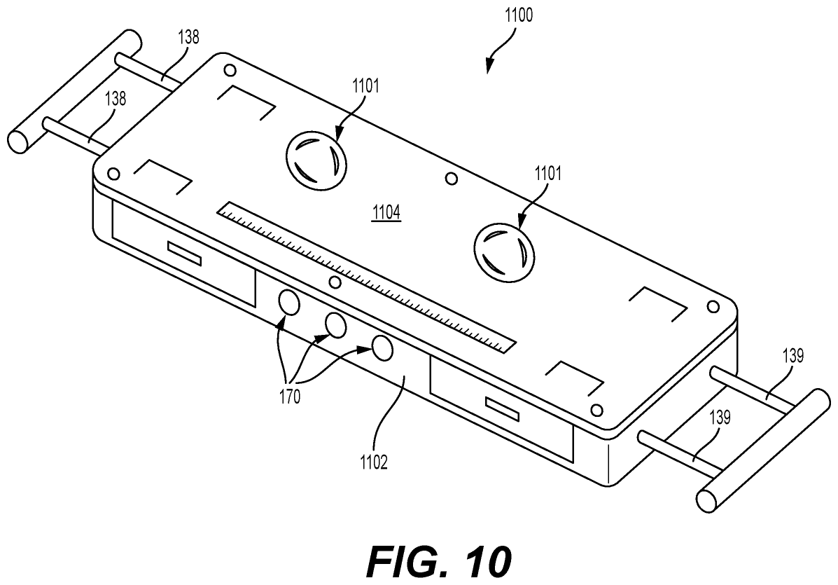

Referring to FIG. 10, a tailgate assembly 1100 according to an alternative embodiment of the present technology is shown. Features of the tailgate assembly 1100 similar to those of the tailgate assembly 100 have been labeled with the same reference numerals, and will not be re-described herewith.

The tailgate assembly 1100 includes the tailgate body 1102 and the tailgate sub-body 1104.

The tailgate assembly 1100 notably differs from the tailgate assembly 100 in that the extension members 138, 139 are configured to extend generally outwardly from the lateral sides 114, 115 of the tailgate body 1102. Additionally, the tailgate body 102 defines connecting apertures 170 on the top side 112 thereof (instead of the recess 122 and the removable case 132). Additionally, the tailgate sub-body 1100 has twist-and-lock mechanisms 1101, which can enable easy connection of accessories to the tailgate assembly 1100.

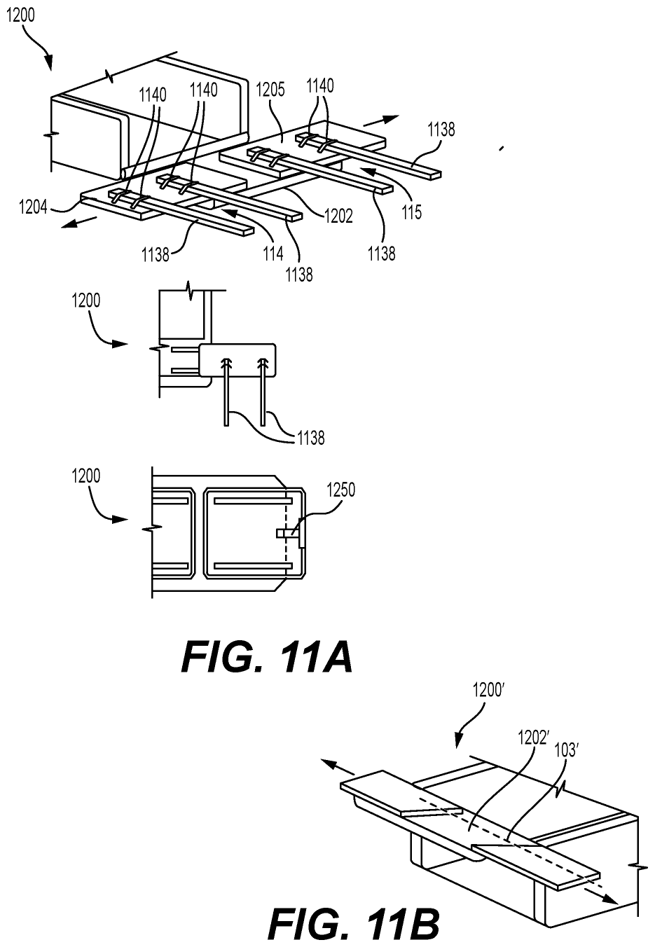

Referring to FIG. 11A, a tailgate assembly 1200 according to an alternative embodiment of the present technology is shown. Features of the tailgate assembly 1200 similar to those of the tailgate assembly 100 have been labeled with the same reference numerals, and will not be re-described herewith.

The tailgate assembly 1200 includes the tailgate body 1202, a tailgate sub-body 1204 and a tailgate sub-body 1205. Thus, the tailgate assembly 1200 notably differs from the tailgate assembly 100 in that the tailgate assembly 1200 includes two tailgate sub-bodies.

In this embodiment, the tailgate sub-bodies 1204, 1205 are moveably connected to the tailgate body 1202 via rails 1214. Thus, the tailgate sub-bodies 1204, 1205 are slidingly connected to the tailgate body 1202, and are configured to move linearly relative thereto. The tailgate sub-bodies 1204, 1205 are configured such that when they move away from the closed position, they move laterally, resulting in them extending beyond the lateral sides 114, 115 of the tailgate body 1202. It is contemplated that in some embodiments, the tailgate sub-bodies 1204, 1205 may be moveable along the top and bottom sides 112, 113.

Additionally, the tailgate assembly 1200 includes extension members 1138 that are selectively connected to the tailgate sub-body 1204 via retaining members 1140, and extension member 1140 that are selectively connected to the tailgate sub-body 1204 via retaining members 1142.

Sub-body locking assemblies 1250 are also shown and being configured to lock the tailgate sub-bodies 1204, 1205 in the closed position.

With reference to FIG. 11B, a tailgate assembly 1200′ is shown. In this embodiment, the axis 103′ is disposed toward the front side 110, and the top side 112 of the tailgate body 1202′, such that the orientation of the pivotal movement of the tailgate body 1202′ is different.

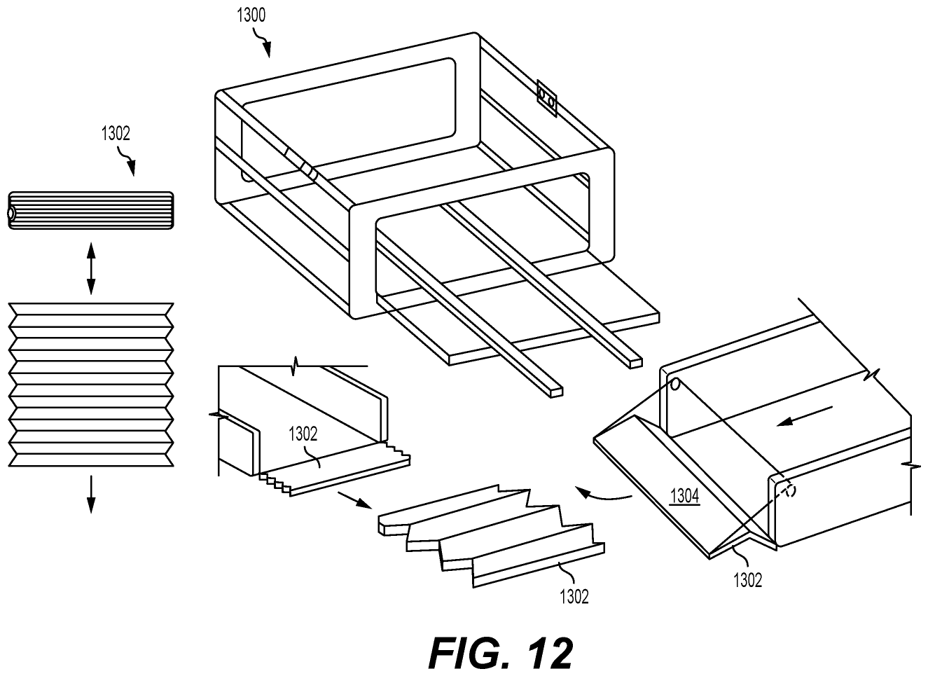

Referring to FIG. 12, a tailgate assembly 1300 according to an alternative embodiment of the present technology is shown. Features of the tailgate assembly 1300 similar to those of the tailgate assembly 100 have been labeled with the same reference numerals, and will not be re-described herewith.

The tailgate assembly 1300 includes the tailgate body 1302 and the tailgate sub-body 1304.

The tailgate assembly 1100 notably differs from the tailgate assembly 100 in that the tailgate sub-body 1304 has an origami configuration, such that it is adjustable between a collapsed configuration and an extended configuration. When in the extended configuration, the tailgate sub-body 1304 can provide a working surface. In some embodiments, it is the tailgate sub-body 1304 that may have the origami configuration. Additionally, in some embodiments, when the tailgate body 1304 moves from the closed position to the first open position, it can unfold open, which can increase a working area provided thereby.

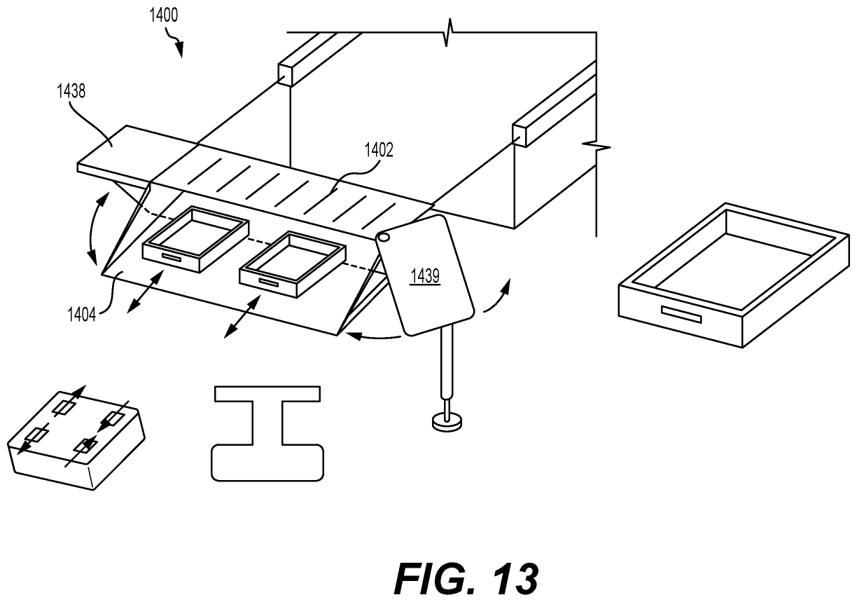

Referring to FIG. 13, a tailgate assembly 1400 according to an alternative embodiment of the present technology is shown. Features of the tailgate assembly 1400 similar to those of the tailgate assembly 100 have been labeled with the same reference numerals, and will not be re-described herewith.

The tailgate assembly 1400 includes the tailgate body 1402 and the tailgate sub-body 1404.

The tailgate assembly 1400 notably differs from the tailgate assembly 100 in that the tailgate assembly 1400 has extension members 1438, 1439 that are integrated with to the tailgate body 1402. More specifically, the extension members 1438, 1439 can be pivoted between retracted and deployed positions. The extension members 1438, 1439 can have other extension members connectable thereto. Additionally, the extension members 1438, 1439 may have storage containers 1450 connected thereto.

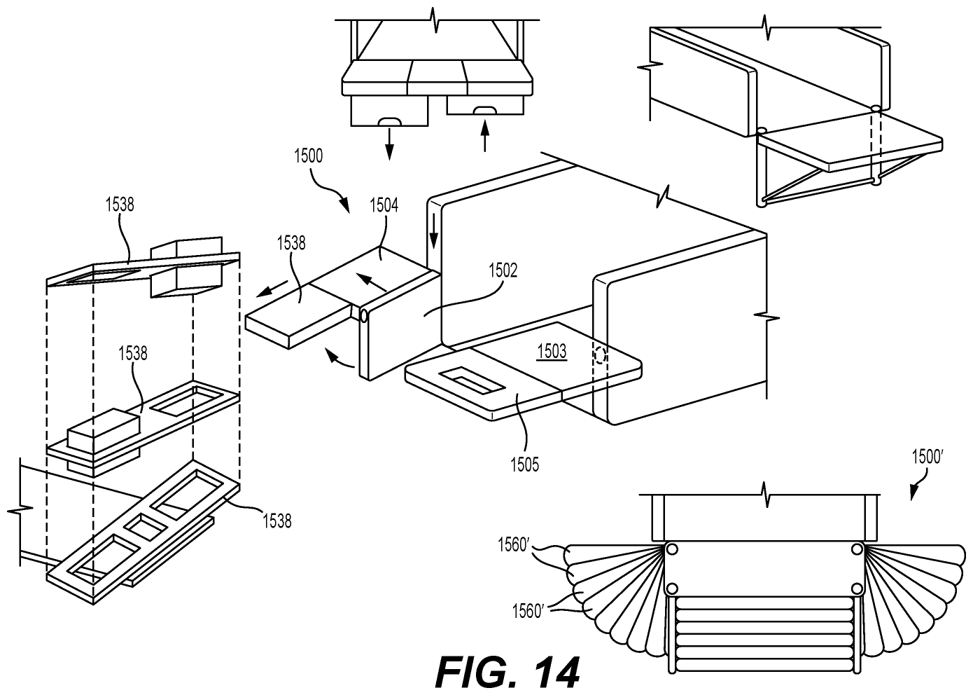

Referring to FIG. 14, a tailgate assembly 1500 according to an alternative embodiment of the present technology is shown. Features of the tailgate assembly 1500 similar to those of the tailgate assembly 100 have been labeled with the same reference numerals, and will not be re-described herewith.

The tailgate assembly 1500 includes a tailgate body 1502, a tailgate body 1503, a tailgate sub-body 1504, and a tailgate sub-body 1505.

In this embodiment, the tailgate bodies 1502, 1503 are pivotally connected to the frame 52 about vertical axes, and are independently moveable with respect to one another. The tailgate bodies 1502, 1503 are also fully removable from the frame 52.

The tailgate sub-body 1504 is pivotally connected to the tailgate sub-body 1502, and has an extension member 1538 that is deployable therefrom. The extension member 1538 may define apertures configured to receive accessories therein.

In some embodiments, a tailgate assembly 1500′ has segments 1560′ that deploy as the tailgate bodies 1502′, 1502′ are opened.

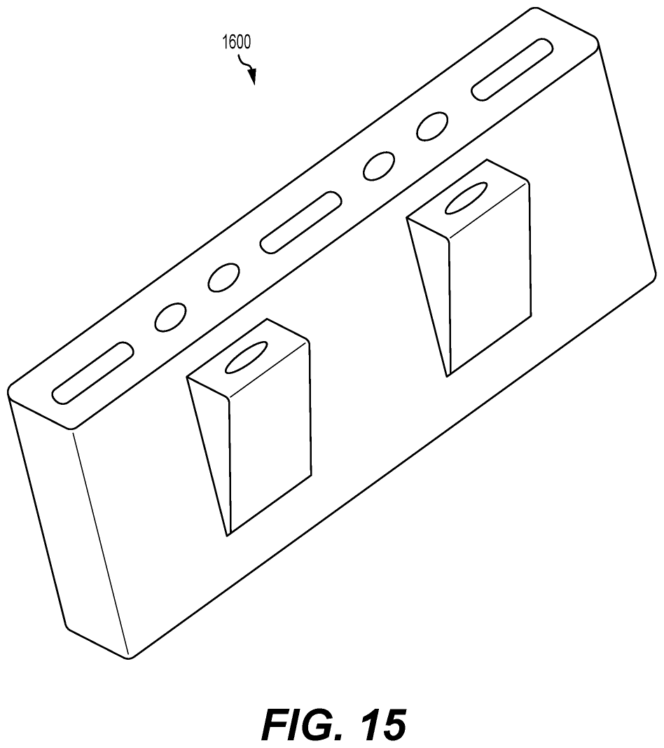

Referring to FIG. 15, a tailgate assembly 1600 according to an alternative embodiment of the present technology is shown. The tailgate assembly 1600 is configured to support different tools.

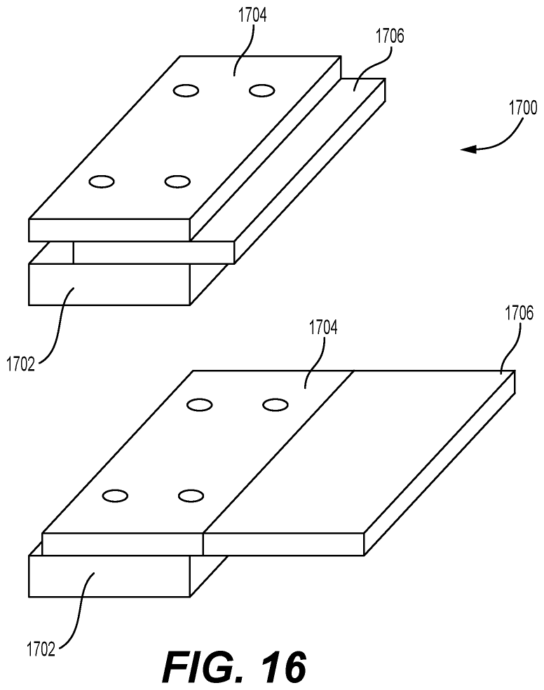

Referring to FIG. 16, a tailgate assembly 1700 according to an alternative embodiment of the present technology is shown. Features of the tailgate assembly 1700 similar to those of the tailgate assembly 100 have been labeled with the same reference numerals, and will not be re-described herewith.

The tailgate assembly 1700 includes a tailgate body 1702 and a tailgate sub-body 1704, and an extension panel 1706.

In this embodiment, the extension panel 1706 is received between (i.e., sandwiched between) the tailgate body 1702 and the tailgate sub-body 1704. The extension panel 1706 is slidable out thereof. In some instances, the tailgate sub-body 1704 may move vertically downward such that the tailgate sub-body 1704 is flush with the extension panel 1706. This is notably advantageous in that accessories and/or features disposed on the tailgate sub-body 1470 may still be advantageous.

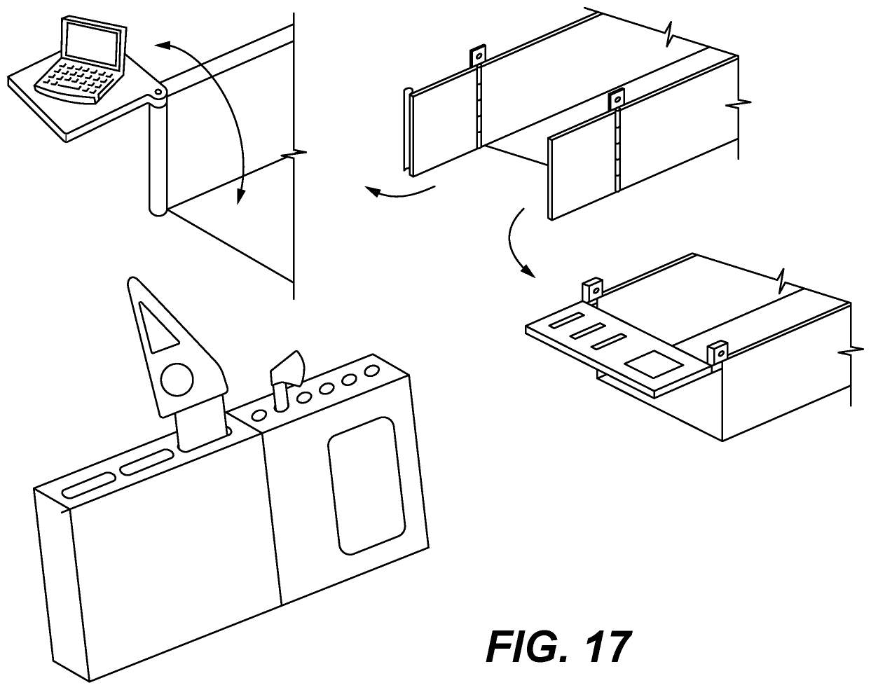

FIG. 17 depicts tailgate bodies moving in different ways.

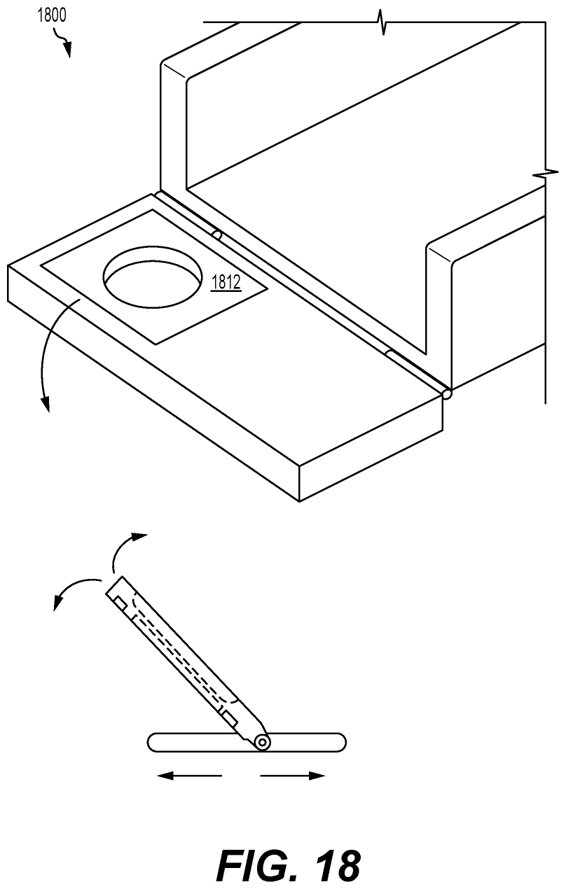

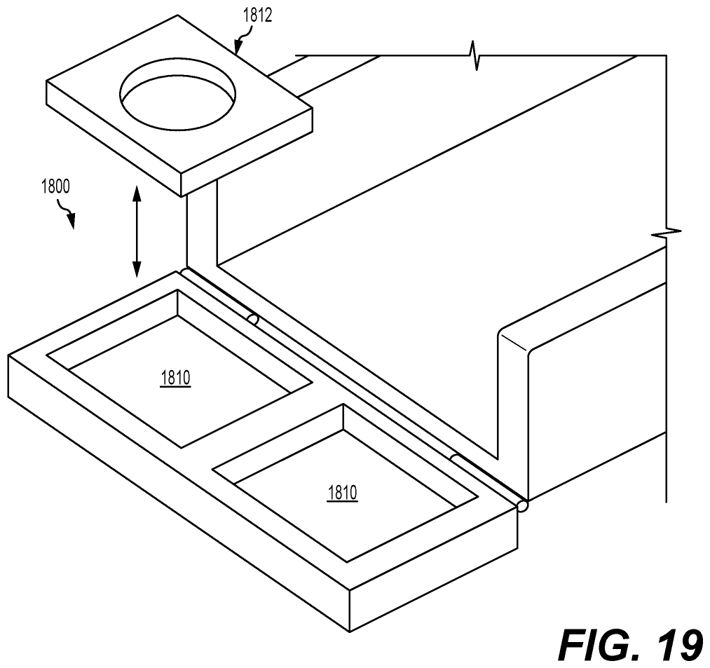

Referring to FIGS. 18 and 19, a tailgate assembly 1800 according to an alternative embodiment of the present technology is shown. Features of the tailgate assembly 1800 similar to those of the tailgate assembly 100 have been labeled with the same reference numerals, and will not be re-described herewith.

The tailgate assembly 1800 includes a tailgate body 1802 which has magnets 1810 thereon. The tailgate assembly 1800 also has a custom plate 1812 selectively connectable to any one of the magnets 1810.

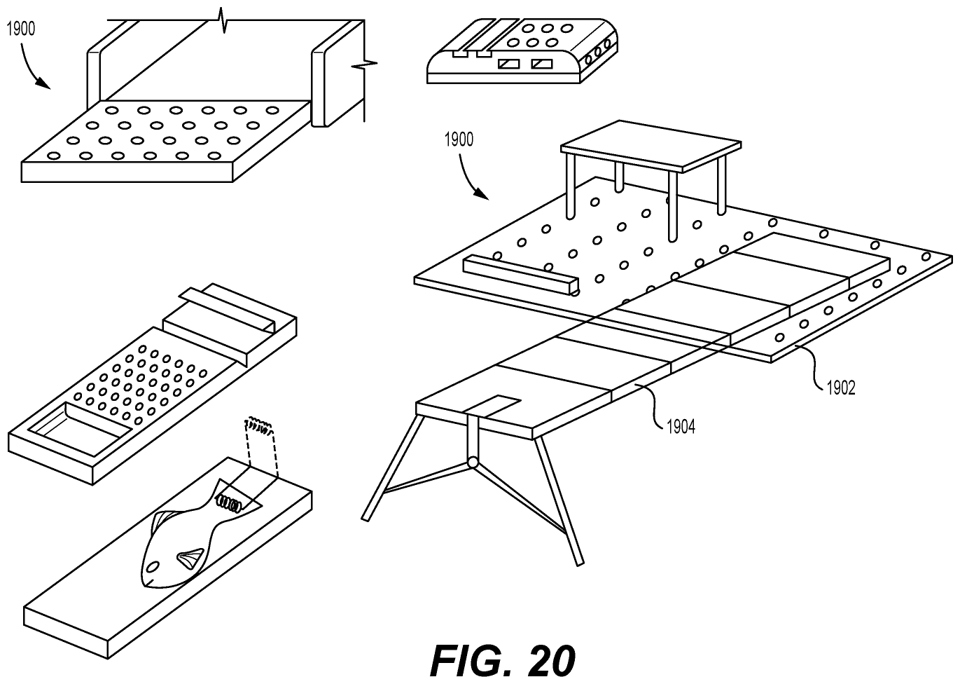

Referring to FIGS. 20, a tailgate assembly 1800 according to an alternative embodiment of the present technology is shown. Features of the tailgate assembly 1800 similar to those of the tailgate assembly 100 have been labeled with the same reference numerals, and will not be re-described herewith.

The tailgate assembly 1800 has a tailgate body 1802 and a tailgate sub-body 1804. The tailgate body 1802 defines a plurality of apertures 1810 for mounting accessories thereto. The tailgate sub-body 1804 has been connected thereto and is deployable therefrom. Other accessories are also shown connected to the tailgate body 1802.

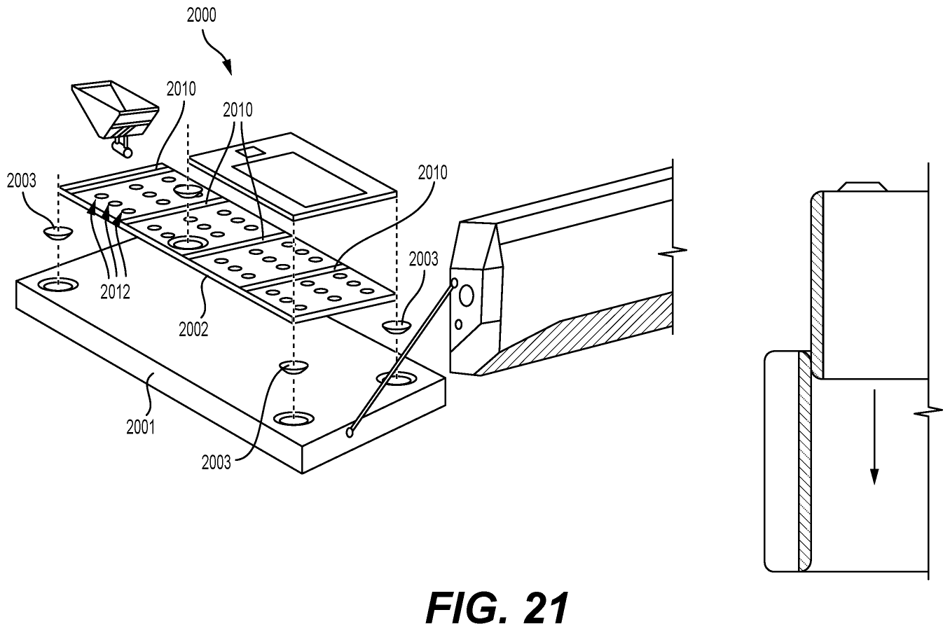

With reference to FIG. 21, an add-on tailgate assembly 2000 according to another aspect of the present technology is shown. The add-on tailgate assembly 2000 is configured to connect to an existing tailgate 2001 of the vehicle 50.

The add-on tailgate assembly 2000 includes a tailgate body 2002 that is connected to the existing tailgate 2001. In some embodiments, the tailgate body 2002 is removably connected to the existing tailgate 2001. In some embodiments, the tailgate body 2002 is moveable relative to the existing tailgate 2001 (i.e., pivotally or translationally).

In some cases, the tailgate body 2002 is a liner covering at least one surface of the existing tailgate 2001. In one embodiment, the tailgate body 2002 is attached to the front surface of the existing tailgate 2001 and covers at least the front surface thereof. The tailgate body 2002 connected to the existing tailgate 2001 via quick-attach assemblies 2003. In other embodiments, the tailgate body 2002 may be connected to the existing tailgate 2001 differently, such as for example, via fasteners, via clamps, via glue, via an adhesive, via snaps or via rivets.

The tailgate body 2002 has rails 2010 (t-slot) and defines apertures 2012 that enable accessories to be connected to thereto.

In some embodiments, the tailgate assembly 2000 can further include a tailgate sub-body that is at least partially separate from the tailgate body and that is moveable relative to the tailgate body. In some cases, the tailgate sub-body is removably and/or pivotally connected to the tailgate body.

It is understood that features described above with respect to the tailgate assemblies 100, 1100, 1200, 1300, 1400, 1500, 1600, 1700, 1800 may be applicable to the add-on tailgate assembly 2000.

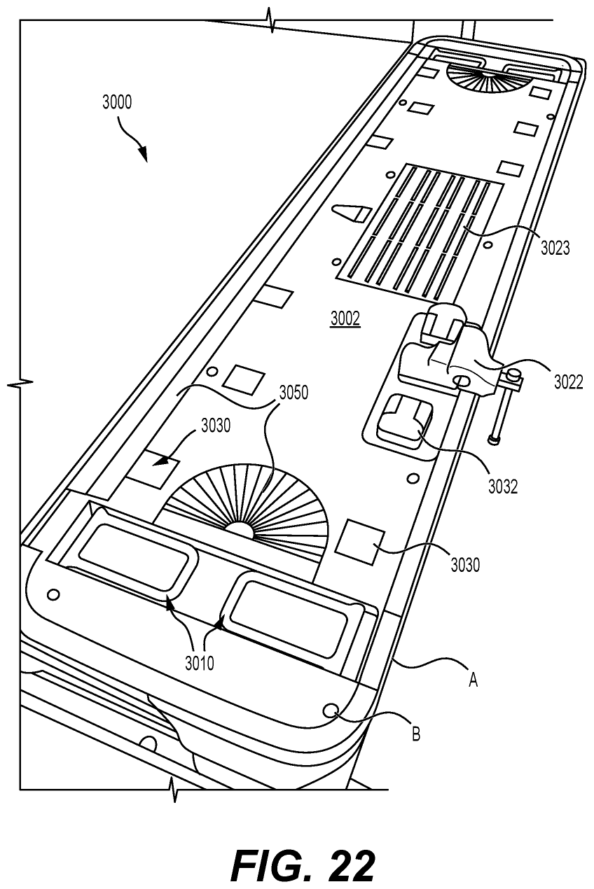

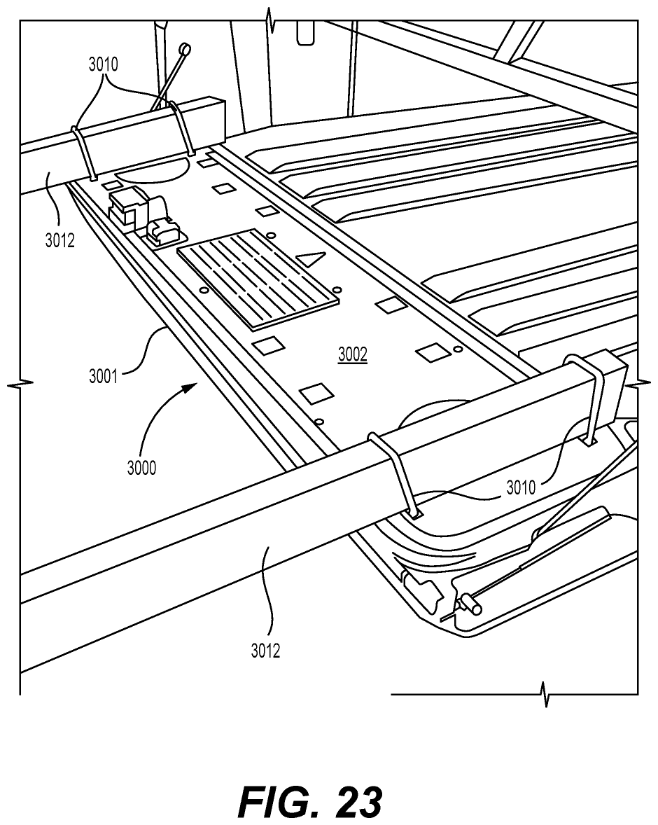

Referring to FIGS. 22 and 23, an add-on tailgate assembly 3000 according to an alternative embodiment is shown. The add-on tailgate assembly 3000 is connected to an existing tailgate 3001.

The add-on tailgate assembly 3000 includes a tailgate body 3002 that is connected to the existing tailgate 3001.

The tailgate body 3002 includes fixation members 3010 configured to receive extension member 3012 therein. In FIG. 23, the extension members 3012 are studs. Other extension members and/or sub-assemblies are contemplated. The extension members 3012 may provide support for accessories or additional extension sub-assembly (e.g., workbench).

Additionally, the tailgate body 3002 has provisions or mounting features for installing an accessory such as a vise 3022 and a magnetic plate 3023. The accessory may be disposed on at least one of the front, rear, top, bottom, left and right surfaces. In this embodiment, the front surface has a plurality of apertures 3030 configured to receive a fastener at multiple discrete positions to mount an accessory or to provide a tie-down point. Instead of or in addition of a plurality of apertures, the tailgate body can provide at least one rail for continuous positioning of a fastener to mount an accessory or to provide a tie-down point along the at least one rail. In some cases, the plurality of apertures can be sized and shaped to receive specific quick-attach mechanisms 3032. The tailgate body 3002 also has measuring tools 3050.

In some embodiments, the tailgate assembly 2000 can further include a tailgate sub-body 2004 that is at least partially separate from the tailgate body 2002 and that is moveable relative to the tailgate body 2002. In some cases, the tailgate sub-body 2004 is removably and/or pivotally connected to the tailgate body 2004.

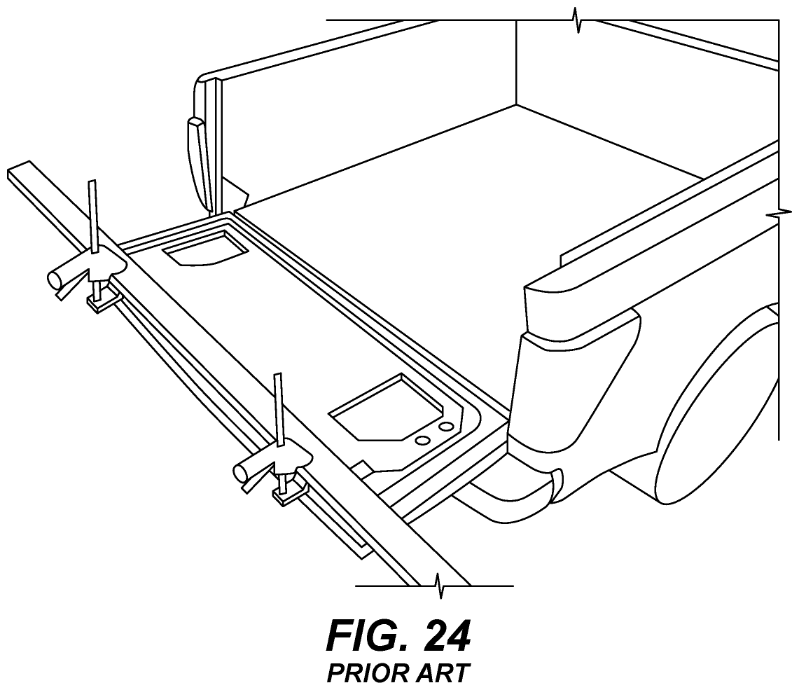

FIG. 24 shows a conventional tailgate assembly with a stud disposed thereon with clamps. This may not be safe, and may be detrimental to the conventional tailgate.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A tailgate assembly for a vehicle, the tailgate assembly comprising:
a tailgate body pivotally connectable to the vehicle about a first axis and defining a first tailgate body position and a second tailgate body position relative to the vehicle,
the tailgate body defining at least one storage area configured to receive at least one object;
a tailgate sub-body pivotally connectable to the tailgate body about a second axis and defining a first tailgate sub-body position and a second tailgate sub-body position relative to the tailgate body; and
a link connecting the tailgate body to the tailgate sub-body via at least one set of two attachment points, wherein a first set of two attachment points is configured to position the tailgate sub-body in the first tailgate sub-body position and wherein a second set of two attachment points is configured to position the tailgate sub-body in the second tailgate sub-body position,
wherein a plurality of combinations of at least one of the first and second tailgate body positions relative to the vehicle with at least one of the first and second tailgate sub-body positions relative to the tailgate body forms a plurality of different configurations for different usage of the tailgate assembly by a user.

2. The tailgate assembly of claim 1, wherein one of the plurality of different configurations provides at least one of an additional work surface and a step.

3. (canceled)

4. The tailgate assembly of claim 1, wherein the tailgate body is hollow and configured to provide internal storage.

5. The tailgate assembly of claim 1, wherein the tailgate body is configured to provide at least one of: provisions for an extension sub-assembly, and provisions for mounting an accessory.

6. (canceled)

7. The tailgate assembly of claim 1, wherein the tailgate assembly is configured to replace an existing tailgate assembly on the vehicle.

8. (canceled)

9. A tailgate assembly for a vehicle, the tailgate assembly comprising:
a tailgate body removably connectable to a tailgate of the vehicle defining a first tailgate position and a second tailgate position relative to the vehicle,
the tailgate body defining at least one storage area configured to receive at least one object;
a tailgate sub-body pivotally connectable to the tailgate body about a second axis and defining a first position and a second position relative to the tailgate body; and
a link connecting the tailgate body to the tailgate sub-body via attachment points, a first set of two attachment points is configured to position the tailgate sub-body in the first position and wherein a second set of two attachment points is configured to position the tailgate sub-body in the second position,
wherein a plurality of combinations of at least one of the first and second tailgate positions relative to the vehicle with at least one of the first and second positions of the tailgate sub-body relative to the tailgate body forms a plurality of different configurations for different usage of the tailgate assembly by a user.

10. The tailgate assembly of claim 9, wherein one of the plurality of different configurations provides at least one of: an additional work surface, and a step.

11. (canceled)

12. The tailgate assembly of claim 9, wherein the tailgate body is hollow and configured to provide internal storage.

13. The tailgate assembly of claim 9, wherein the tailgate body is configured to provide provisions for at least one of: an extension sub-assembly, and mounting an accessory.

14. (canceled)

15. The tailgate assembly of claim 9, wherein the tailgate assembly is configured to be installed onto an existing tailgate assembly on the vehicle.

16. The tailgate assembly of claim 9, wherein the tailgate body is a liner covering at least one surface of the tailgate of the vehicle.

17. (canceled)

18. A tailgate assembly for a vehicle, the tailgate assembly comprising:
a tailgate body pivotally connectable to the vehicle, the tailgate body:
being pivotable relative to the vehicle about a first axis between a first position and a second position; and
defining at least one storage area;
a tailgate sub-body connected to the tailgate body, the tailgate sub-body being moveable relative to the tailgate body between a third position and a fourth position;
a link connected to the tailgate body and the tailgate sub-body, the link being moveable between:
a first link position, in which the tailgate sub-body is in the third position; and
a second link position, in which the tailgate sub-body is in the fourth position;
with the tailgate body in the first position, and the link in the first link position, the tailgate assembly is in a first configuration; and
with the tailgate body in the second position, and the link in the second link position, the tailgate assembly is in a second configuration.

19. The tailgate assembly of claim 18, wherein the link is selectively connected to at least one of the tailgate body and the tailgate sub-body.

20. The tailgate assembly of claim 18, wherein the link is selectively connected to the tailgate body via one of: a first attachment point and a second attachment point.

21. The tailgate assembly of claim 18, wherein the tailgate sub-body is pivotable about a second axis.

22. The tailgate assembly of claim 18, wherein in one of the first and second configurations, the tailgate sub-body provides one of: a work surface, and a stepping surface.

23. The tailgate assembly of claim 18, wherein in one of the first and second configurations, the tailgate assembly is configured to support a work surface.

24. (canceled)

25. The tailgate assembly of claim 18, wherein the tailgate body is at least partially hollow and the storage is an internal storage.

26. (canceled)

27. The tailgate assembly of claim 18, wherein the tailgate body includes an extension assembly.

28. The tailgate assembly of claim 27, wherein the extension assembly includes telescoping members.

29.-30. (canceled)
